(19) United States
(12) Patent Application Publication
(10) Pub. No.: US 2012/0177086 A1
(43) Pub. Date: Jul. 12, 2012

(54) System And Apparatus Employing Programmable Transceivers

(75) Inventor: Thomas Drago, Rockledge, FL (US)

(73) Assignees: Space Administration, Washington, DC (US); United States of America as represented by the Administrator of the National Aeronautics and

(21) Appl. No.: 13/216,671

(22) Filed: Aug. 24, 2011

Related U.S. Application Data
(60) Provisional application No. 61/411,758, filed on Nov. 9, 2010.

(51) Int. Cl. H04B 1/38

(52) U.S. Cl. 375/219

(57) ABSTRACT

The present invention is directed to a system and apparatus employing programmable transceivers in space-related missions. More particularly, the system and apparatus transceiver employs two types of telemetry data, one at a low data rate communications protocol and another at a high data rate communications protocol. The transceiving mechanisms are also modular and flexible, allowing remote reconfigurations, emulations and testing.

### CROSS-REFERENCE TO RELATED APPLICATIONS

The present invention claims priority from U.S. Provisional Patent Application Ser. No. 61/411,758, filed Nov. 29, 2010, the subject matter for which is incorporated herein by reference.

### ORIGIN OF THE INVENTION

The invention described herein was made by an employee of the United States Government, and may be manufactured and used by or for the Government for governmental purposes without the payment of any royalties thereon or therefor.

### BACKGROUND OF THE INVENTION

1. Field of the Invention

The present invention is in the technical field of programmable transceivers for usage in space and atmospheric exploration.

2. Description of Related Art

The exploration of space requires reliable communications, whether the mission is manned or un-manned. The need for reliable telemetry is manifest, and a variety of equipment have been deployed to manage the evolving and increasingly-demanding requirements of space telecommunications.

This need is particularly acute because the telemetry communications between ground-based systems and orbiting systems require two different types of communications links, one slow and one fast, to accommodate the equipment constraints of the various telecommunications devices. At present, there are no devices capable of simultaneously handling the diverse needs currently being demanded necessitating new approaches, such as set forth here.

The National Aeronautics and Space Administration (NASA) has been at the forefront of technology for such communications. With the diverse needs of current and upcoming NASA space links, there is a growing need for both highly reliable, low data rate communications links, such as used in supporting critical telemetry, tracking and command (TT&C), ranging and voice services, and highly-efficient, high data rate links, supporting mission or payload data.

There is, therefore, a need for transceiving devices incorporating the capabilities of both low-speed and high-speed communications for telemetry and mission data.

Further, there is a need for such devices that are also modular and flexible in design, allowing flexibility both before and more importantly after launch, thereby minimizing or eliminating the need for manned missions to adjust or fine tune orbiting devices, or devices or probes that are in deep space and incapable of such attempts.

With the need for flexibility in such communications, there is also a need for an improved platform on which to develop, test and optimize new algorithms and modulations techniques, and so in high-speed and with ease of reconfigurability. As discussed, with many probes deep in space and away from Earth orbit, there is a strong need for these remote devices to have on-the-fly adaptability. The successes with reconfiguring the Galileo probe to Jupiter and other far away instruments amply demonstrate the need for remote reconfiguring capabilities.

### SUMMARY OF THE INVENTION

The present invention is directed to a system and apparatus employing programmable transceivers in space-related missions. More particularly, the system and apparatus transceiver employs two types of telemetry data, one at a low data rate communications protocol and another at a high data rate communications protocol. The transceiving mechanisms are also modular and flexible, allowing remote reconfigurations, emulations and testing.

### BRIEF DESCRIPTION OF THE DRAWINGS

While the specification concludes with claims particularly pointing out and distinctly claiming the subject matter that is regarded as forming the present invention, it is believed that the invention will be better understood from the following Detailed Description, taken in conjunction with the accompanying Drawings, where like reference numerals designate like structural and other elements, in which:

FIG. 1 is an illustration of an embodiment of the system and apparatus of the present invention.

### DETAILED DESCRIPTION OF THE INVENTION

The present invention will now be described more fully hereinafter with reference to the accompanying Drawings, in which preferred embodiments of the invention are shown. It is, of course, understood that this invention may, however, be embodied in many different forms and should not be construed as limited to the embodiments set forth herein; rather, these embodiments are provided so that the disclosure will be thorough and complete, and will fully convey the scope of the invention to those skilled in the art. It is, therefore, to be understood that other embodiments can be utilized and structural changes can be made without departing from the scope of the present invention.

As described, current and upcoming NASA space links require both highly reliable, low-rate communications links, supporting critical telemetry, tracking and command (TT&C), ranging and voice services, and highly-efficient, high-data rate links, supporting mission or payload data. The instant invention addresses these and other concerns of evolving technologies and changing real world economic constraints.

In particular, the present invention is also directed to the investiture in re-usable elements, such as programmable communications radios for ground and flight data handling, that are capable of receiving both kinds of links, and address current communication and navigation needs without foregoing future capabilities.

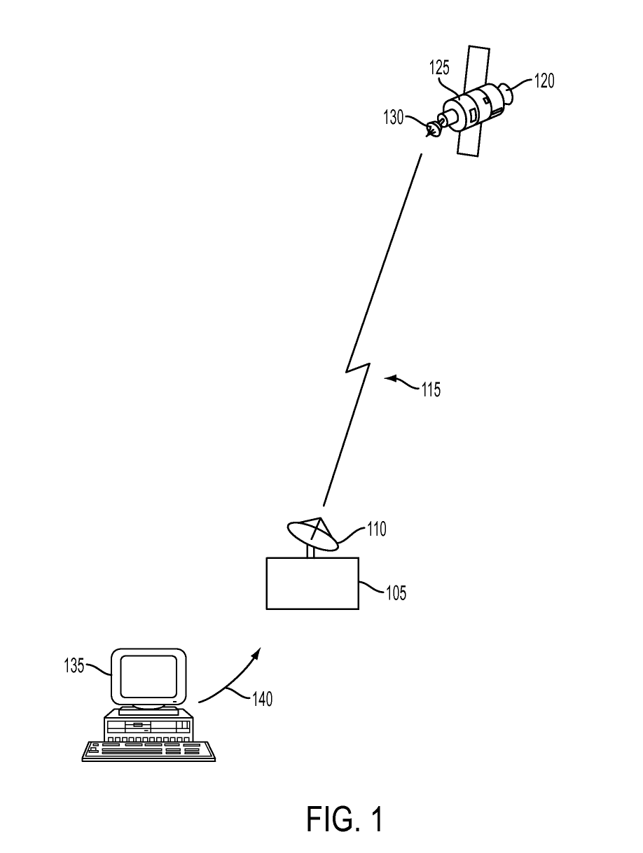

With reference to FIG. 1 of the Drawings, there is illustrated a programmable transceiver system, as well as apparatus, employed in practicing the present invention. The system, generally designated by the reference numeral 100, has an Earth-based transceiver 105, which includes an antenna 110, in a communications link, generally designated by the reference numeral 115, with a remote or space-based satellite or probe 120, which also includes a transceiver 125 and an antenna 130.

With reference again to FIG. 1, the transceivers 105 and 125 incorporate at least two communications protocols for transceiving data across the aforementioned communications link 115. The electronics and software in both transceivers 105 and 125 have both a reliable, albeit slow data rate, communications protocol and a cost-effective, high data rate communications protocol.

Additionally, the system and apparatus of the present invention are also directed to the development, testing, and optimization of new algorithms and modulation schemes or techniques that require a high-speed platform able to be reconfigured, as needed. For example, a user at a computer 135 can upload reconfiguration parameters to the satellite or probe 120 via the transceivers 105 and 125, e.g., via a wireline or wireless connection 140, preferably using the aforementioned high data rate communication protocol, whereupon changes can be made remotely. One demand driver for this development was as a waveform evaluation platform at the Goddard Space Flight Center (GSFC), where it was determined that a modular and flexible High Rate Receiver Backbone (HRRB) allows customization of some processing firmware, and accommodates advances in deployed link formats more easily than units factory-loaded for particular signal types.

In this fashion, a programmable high-rate multi-mission receiver, pursuant to the teachings of the present inventions, will enable NASA and other space-oriented entities and companies to support multiple missions and data link types with a single, flexible receiver, thereby overcoming a host of problems associated with prior art devices.

Utilizing highly-reconfigurable receivers for Communications and Navigation (C&N) tasks in networks and trunking links, Systems Research, Inc. (SRI) research indicates that NASA, in particular, will benefit from a design that supports (1) high data rate links for Deep Space, Near-Earth, Lunar and Martian Relay missions, (2) low data rate links for critical TT&C, ranging and voice services, (3) Ground Earth Elements (GEE) and Range Upgrade and Modernization within the Deep Space Network (DSN), ground Network (GN), Space Network/Tracking and Data Relay Satellite System (SN/TDRSS), Spaceflight Tracking and Data Network (STDN) and related networks, as are understood in the art. Additionally, using the system and apparatus of the present invention, NASA will benefit from a flexible and reusable platform for R&D and optimization efforts.

It should, of course, be understood that with the rise in commercial launch and exploration vehicles, there are a variety of non-NASA business applications for a highly-programmable satellite, space, and range link receiver, supporting low-rate TT&C, as well as high-rate imaging, and other bandwidth intensive mission data links include, which by way of representation, include following:

(1) the Department of Defense (DoD) International Symposium on Computer Networks (ISCN),

(2) Transformational Satellite (TSAT), Federation of Communications Services (FCS), Global Information Grid (GIG) and other DoD networking initiatives envisioning data rates at or near 1 Gbps,

(3) commercial networks, such as Universal Space Network, Inc. and DataLynx that would be interoperable with NASA assets, offering potential off-loading for particular missions,

(4) imaging organizations, such as Orbimage, DigitalGlobe, United States Geological Survey (USGS), and National Oceanic and Atmospheric Administration (NOAA) missions, such as Geosynchronous Operational Satellite (GOES-R) and Landsat data Continuity Mission (LDCM) that provide bandwidth intensive satellite imaging, and Earth Observation products,

(5) links required for imaging and other TT&C and high-bandwidth payload transmissions from unmanned aerial vehicles (UAVs) and related non-satellite/non-space platforms, as are understood in the art, and

(6) many other initiatives where the principles of the present invention are applicable and deployed.

As indicated, the present invention also addresses a nascent market for Synthetic or Virtual Instrumentation. This market uses general purpose hardware that is intended to perform many different kinds of signal capture and analysis functions, as is understood in the art. These tasks often require high-speed, low noise digitization and signal processing equipment that is flexible enough to be used for a variety of tasks. For example, a user of the computer 135 in FIG. 1 may run virtual simulations or synthetics of a possible space mission to test the components of the devices, such as the system and apparatus of the present invention. Although this market is new, the requirements of a Programmable High-Rate Multi-Mission Receiver (PHMR) or High Rate Receiver Backbone (HRRB) are similar to equipment available in this market.

It should, of course, be understood that the development of a programmable communications radio pursuant to the present invention is driven principally by ongoing and upcoming needs of the Communication and Navigation (C&N) services within NASA Space Exploration and Science missions for programmable communications radios servicing ground-based elements of NASA's communications networks. Ground Communications Equipment (GCE), either in the current Deep Space Network (DSN) and Ground Network (GN) or evolving advanced architectures, such as the Ground Earth Elements (GEE) of a new Space Communications Architecture (SCA), support the provision of communications services to space missions operating anywhere in the Solar System and beyond.

It should be understood that the intelligent use of an integrated networking architecture that leverages modern programmable communication techniques provides a seamless transition for users going from one element service to another.

NASA's communications capability is based on the premise that communications shall enable and not constrain missions. Communications must be robust to support the numerous missions for space science, Earth science and exploration of the universe. Accordingly, the probe 120 may venture billions of miles from the Earth, beyond physical reach for decades or a very long time. Technologies, such as reprogrammable communications systems, are, therefore, very important to the future of the exploration and science activities of the agency. The evolving nature of NASA's exploration and science programs, the evolving communication standards, as well as the evolving capabilities of the space communication infrastructure, demand and require a measure of adaptability provided through the technological solutions proposed and claimed herein. The reconfiguration capabilities of a reprogrammable radio can adapt to transitions in capability, protocols, waveforms, and network structure by allowing multiple configurations within a single mission, removing the need for multiple radios or for a single complex multi-function hardware radio.

Additionally, if a spectrum architecture is defined that enables the elements to provide interoperable C&N services throughout the solar system, then two or more communication channels may be made available to each user spacecraft. Thus, robust, highly reliable, low data rate communications links, supporting critical Tracking, Telemetry and Command (TT&C), ranging and voice services, and bandwidth-efficient, high-data rate communications links supporting Mission or Payload Data return, are possible pursuant to the teachings of the present invention.

The aforedescribed High Rate Receiver Backbone (HRRB) and resulting Programmable High-Rate Multi-Mission Receiver (PHMR) communications platforms of the instant invention are designed to reliably and cost-effectively address these two requirements. Both are important to the success of new missions, and for many ongoing missions that rely on aging ground element equipment. It should, of course, be understood that the need to replace this aging equipment prior to an unrecoverable capability failure in ongoing mission tasks can conflict with yet-to-be-determined range upgrade, modernization and mission requirements. Investing in re-usable elements, such as Programmable Communications Radios (PCRs), for ground and flight data handling that are capable of receiving both highly-reliable low rate links and highly-efficient high-rate links addresses current needs without foregoing future capability requirements.

Power and spectrum efficient solutions are needed for both near-Earth and deep-space science and exploration applications. Channel coding efficiencies from 50% to 87%, combined with good bit-error/burst-error correction property are needed to provide solutions for multiple missions. A high-speed, digital receiver capable of demodulating coded modulations, in addition to un-coded modulations, is also needed for future missions. For many applications, a high-rate receiver capable of decoding coded and un-coded modulation suite (8-PSK, GMSK, filtered OQPSK) specified by CCSDS 413.0-G-1 Apr. 2003 (www.ccsds.org) and 16-PSK, 16-QAM, 16-APSK with processing throughput greater than 300 Mbits/sec is desirable and preferable.

Additionally, for research and development of new channel modulation and coding algorithms, a 7 bits/sample soft-decision output that can be used as input to channel decoding algorithms based on soft-decision decoding, as well as supporting user-reprogrammable elements, such as decoding, descrambling, and alternative waveform processing.

As is understood in the art, the development, testing and optimization of new algorithms and modulation schemes are often accomplished using general purpose Arbitrary Waveform Generators, Vector Modulators, Noise Sources, and commercial Receiver systems that have been integrated into a specific system configuration. Although some of the devices are user programmable, much of what is used has limited capabilities for user generated waveform coding, shaping, and modulation. A modular and flexible unit with user-reprogrammable Firmware blocks is able to accommodate research and optimization of communications processing techniques more easily than those either factory coded for particular signal types or completely generic, requiring a significant effort to integrate into a test platform.

The system and approaches of the present invention, representative of the activities of Summation Research with NASA, has resulted in two primary application paths addressing these related, but distinct needs for both a Programmable High-Rate Multi-Mission Receiver (PHMR) for operational elements, including ongoing legacy upgrade and maintenance requirements, as well as upcoming mission and SN/GN upgrade efforts and a High-Rate Receiver Backbone (MRRB) for research and development tasks, including waveform and communications techniques and hardware-in-the-loop simulations.

These needs address requirements primarily in the Space Communications and Navigation (SCaN) programs active at GSFC, the Glenn Research Center (GRC), and the Jet Propulsion Laboratory (JPL), but it should be understood that other mission directorates will benefit by the availability of this enabling technology.

As discussed, current and upcoming NASA space link requirements generally include two types of communications links: robust, highly reliable low data rate communications links supporting critical Tracking, Telemetry and Command (TT&C), ranging and voice services, and bandwidth efficient high-data rate communications links supporting Mission or Payload Data return. Both such linkages are important to the success of a mission, and for many ongoing missions that rely on aging ground element equipment. As previously noted, the need to replace this aging equipment prior to an unrecoverable capability failure in ongoing mission tasks may not mesh with other upgrade, modernization and mission requirements. Therefore, investing in reusable elements, such as Programmable Communications Radios (PCRs), for ground and flight data handling that are capable of receiving both highly-reliable low-rate links and highly-efficient high-rate links address the current needs without foregoing future capability requirements.

Most commercial, prior art implementations of Low-Rate or High-Rate receivers, however, focus on waveforms, protocols and bandwidth ranges quite specific to a given new mission or subset of missions. Accordingly, new missions or changing requirements within existing missions often require the purchase of all new ground equipment, with the corresponding cost of material, training and support. Further, most of the available Low-rate TT&C receivers and transmitters are purpose-built, and include limited capability for high-rate payload data. Likewise, existing high-rate receivers and transmitters either do not support or are not economically practical for use in lower rate requirements.

The High Rate Receiver Backbone (HRRB) and realized Programmable High Rate Multi-Mission Receiver (PHMR) of the present invention, on the other hand, address the common limitations of data rate range and system extensibility by supporting common low data rate TTC links as low as 10 ksps and high data rate payload communications links to 300 Msps for reception of links up to 1.2 Gbps for 8-PSK modulated carriers.

Additionally, the proposed unit provides user access to definable coding blocks valuable in research, development, and testing applications. The basics of signal generation and IF Modulation are taken care of, freeing users to concentrate on signal processing algorithms and techniques. This feature makes the HRRB paradigm of the present invention valuable as a platform for waveform, coding, and other tasks inherent in testing and improving communications algorithms and techniques.

As discussed hereinbelow, there are numerous Non-NASA and commercial business applications and deployment possibilities for a highly programmable satellite, space, and range link receiver pursuit to the present invention supporting low-rate TT&C, as well as high-rate imaging and other bandwidth intensive mission data links. It is anticipated that increasing demands on spectrum will drive adoption of higher-order modulation types to accommodate upcoming bandwidth demands.

A commercialized Programmable High-rate Multi-mission Receiver (PHMR) useful for both low rate TT&C, ranging and voice services, as well as high rate mission data return links, will also address additional NASA uses such as range upgrade and modernization efforts, capabilities needed to support ORS policies; Missions, such as Mars and Lunar Relay links, requiring flexible and upgradeable communications, and navigation links for both network and trunk need as are understood in the art.

The proposed PHMR is functionally similar to units currently used for Radar Signal Processing and Diversity Antenna applications, and, therefore, may be applicable in Antenna Array or Phased Array Ground Cluster initiatives. Soft radio firmware designs are potentially portable to space-qualified platforms that include FPGA, DSP, and ADC/DAC components. These low-power, efficient soft radio implementations provide a basis for implementation in non-GEE applications.

Potential integration with higher-level system functions, at a chassis, module or silicon level, for extremely compact and power-efficient programmable communication blocks are also contemplated in the instant invention. There are many non-NASA business applications and deployment possibilities for a highly programmable satellite, space, and range link receiver supporting low-rate TT&C, as well as high-rate imaging and other bandwidth intensive mission data links SRI anticipates the increasing demands on spectrum will drive adoption of higher order modulation types to accommodate upcoming bandwidth demands. The proposed PHMR would be applicable to a wide range of Governmental and Commercial requirements including: the DoD Integrated Satellite Control Network (ISCN), FCS, MUOS, GIG, and other DoD networking initiatives envisioning data rates at or above 1 Gbps, and Commercial networks, such as Universal Space Network, Inc. and DataLynx that would be interoperable with NASA assets, offering potential offloading for particular missions, imaging organizations, such as Orbimage, DigitalGlobe, USGS, and NOAA missions, such as GOES-R and LDCM that provide bandwidth intensive Earth Observation, and Remote Sensing products, and, communications and range data links required for imaging and other high-bandwidth payload transmissions from UAV and related non-satellite platforms.

A number of providers have been identified that offer products in one or the other of the markets (low or high) addressed by the HRRB and PHMR and each appear to support the demodulation formats desired. These include In-Snec (incl. Enertec), Model: Cortex HDRXXL, Typical Data Rate Range: 500 kbps to 2 Gbps, continuously tunable, Country of Origin: France; RT Logic, Model: T500HR, Typical Data Rate Range: 500 kbps to 1.2 Gbps, continuously tunable, Country of Origin: USA; Avtec, Model: HDRR, Typical Data Rate Range: 10 Mbps to 1.2 Gbps, continuously tunable, Country of Origin: USA; Gray Labs, Model: WDR-MR-UHR, Typical Data Rate Range: 100 Mbps to 600 Mbps, limited tunability, Country of Origin: USA.

While the foregoing written description of the invention enables one of ordinary skill to make and use what is considered presently to be the best mode thereof, it should be understood that various changes, substitutions and alterations can be made herein without departing from the spirit and scope of the invention as defined by the appended claims. Therefore, the invention is not to be limited by the above described embodiment, method, and examples, but by all embodiments and methods within the scope and spirit of the invention as claimed.

I claim:

1. A programmable communications apparatus comprising:
a programmable transceiver, said programmable transceiver capable of communications, via a communications link, with another transceiver,
said programmable transceiver having a first communications linkage means for using a low data rate communications protocol, and a second communications linkage means for transceiving using a high data rate communications protocol.

2. The programmable communications apparatus according to claim 1, wherein said programmable transceiver is a programmable radio.

3. The programmable communications apparatus according to claim 1, wherein said programmable transceiver, during a mission, is reconfigured at least once.

4. The programmable communications apparatus according to claim 1, wherein said communications link comprises at least two channels.

5. The programmable communications apparatus according to claim 1, wherein said first communication linking means employing said low data rate communications protocol supports Tracking, Telemetry and Command (TT&C) functions.

6. The programmable communications apparatus according to claim 1, wherein said first communications linking means employing said low data rate communications protocol supports ranging and voice services.

7. The programmable communications apparatus according to claim 1, wherein said communications link supports links 10 ksps or more.

8. The programmable communications apparatus according to claim 1, wherein said second communications linking means employing said high data rate communications protocol supports mission and payload data return.

9. The programmable communications apparatus according to claim 1, wherein said communications link supports links up to 300 Msps.

10. The programmable communications system according to claim 1, further comprising:
an emulation means for emulating operations of said programmable communications system.

11. A programmable communications system comprising:
a ground-based transceiver; and
a programmable space-based transceiver, said programmable space-based transceiver in a communications link with said ground-based transceiver,
said communications link comprising a first communications linkage means for transceiving using a low data rate communications protocol, and
said communications link further comprising a second communications linkage means for transceiving using a high data rate communications protocol.

12. The programmable communications system according to claim 11, wherein said programmable space-based transceiver is a programmable radio.

13. The programmable communications system according to claim 11, wherein said programmable space-based transceiver, during a mission, is reconfigured at least once.

14. The programmable communications system according to claim 11, wherein said communications link comprises at least two channels.

15. The programmable communications system according to claim 11, wherein said first communication linking means employing said low data rate communications protocol supports Tracking, Telemetry and Command (TT&C) functions.

16. The programmable communications system according to claim 11, wherein said first communications linking means employing said low data rate communications protocol supports ranging and voice services.

7. The programmable communications system according to claim 11, wherein said communications link supports links 10 ksps or more.

18. The programmable communications system according to claim 11, wherein said second communications linking means employing said high data rate communications protocol supports mission and payload data return.

19. The programmable communications system according to claim 11, wherein said communications link supports links up to 300 Msps.

20. The programmable communications system according to claim 11, further comprising:
an emulation means for emulating operations of said programmable communications system.
